(19) United States
(12) Patent Application Publication
(10) Pub. No.: US 2018/0255952 A1
(43) Pub. Date: Sep. 13, 2018

(54) Curtain rod bracket

(71) Applicant: Jennifer Sollers, Humble, TX (US)

(72) Inventor: Jennifer Sollers, Humble, TX (US)

(21) Appl. No.: 15/870,201

(22) Filed: Jan. 12, 2018

Related U.S. Application Data
(60) Provisional application No. 62/445,880, filed on Jan. 13, 2017.

(51) Int. Cl. A47H 1/102; F16B 11/00

(52) U.S. Cl. CPC A47H 1/102; F16B 11/006

(57) ABSTRACT

The present invention provides an adhesive curtain rod bracket for mounting a curtain rod to a wall without the need of drilling. The adhesive curtain rod bracket has a support member perpendicularly attached to a flat member. A hook is placed at the end of the support member and designed to securely hold curtain rods of various sizes. There is a layer of adhesive placed on a rear side of the flat member, allowing a user to easily mount the adhesive curtain rod bracket onto a wall without the need for any tools or drilling.

### FIELD OF THE INVENTION

The present invention relates to curtain rod brackets and more particularly to a curtain rod bracket that will not mark surfaces.

### BACKGROUND

Installing a curtain rod often involves drilling a curtain rod bracket into a wall. This requires the use of tools and can be time consuming. In addition, drilling can leave lasting damage, which can be prohibitive for those living in rental properties or dorm rooms. Some individuals would like to hang curtains on a surface that cannot be drilled into, such as a metal door or piece of crown molding. Furthermore, a curtain rod bracket is ideally drilled into a stud, which often does not perfectly align with the area that a user wishes to hang the curtain. Accordingly, a more flexible curtain rod bracket is needed.

### SUMMARY

A curtain rod bracket to support a curtain rod may include a flat member to attach to a substantially vertical wall and a support member to connect to the flat member to support the curtain rod.

The flat member may include a upward extending arm to connect to the support member.

The flat member may include a pair of upward extending arms to connect to the support member.

The support member may include a hook to support the curtain rod.

The flat member may include a layer of removable adhesive to connect to the vertical wall.

The layer of adhesive may be connected to a tab.

### BRIEF DESCRIPTION OF THE DRAWINGS

FIG. 1 shows a perspective view of a curtain rod hanging on the adhesive curtain rod brackets.

FIG. 2 shows a perspective front and rear view of one embodiment of the adhesive curtain rod brackets.

FIG. 3 shows a perspective view of the adhesive curtain rod bracket being mounted onto the removable base.

FIG. 4 shows a perspective front and rear view of various embodiments of the adhesive curtain rod bracket.

FIG. 5 shows a perspective view of the components of the adhesive curtain rod bracket and of a curtain rod being placed within the hook of adhesive curtain rod bracket.

FIG. 6 illustrates a perspective view of a curtain rod bracket in accordance with the present invention;

FIG. 7 illustrates a top view of the curtain rod bracket of the present invention;

FIG. 8 illustrates a side view of the curtain rod bracket of the present invention;

FIG. 9 illustrates a bottom view of the curtain rod bracket of the present invention;

FIG. 10 illustrates a bottom perspective view of the curtain rod bracket of the present invention;

FIG. 11 illustrates a side view of the curtain rod bracket of the present invention.

### DESCRIPTION OF INVENTION

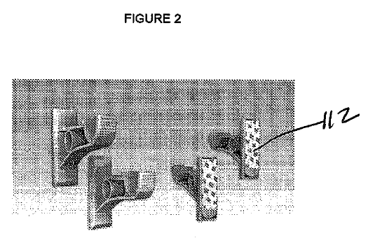

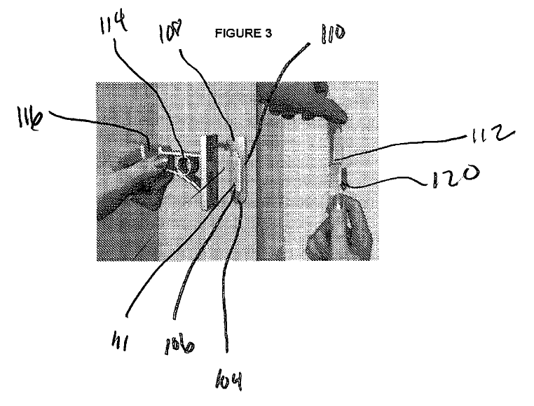

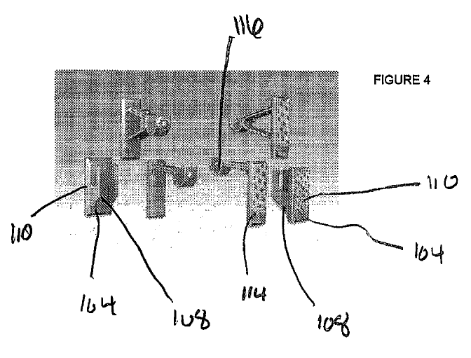

Referring now to FIGS. 2, 3 and 4, there are shown perspective views of various embodiments of the adhesive curtain rod bracket and the adhesive base 112. The adhesive curtain rod bracket 100 comprises a flat member 104 having a front side 108 and a rear side 110, with a support member 114 extending substantially perpendicular from the front side 108. The flat member 104 may include at least one upward extending arm 111 to engage the support member 114. In some embodiments, the rear side 110 of the flat member 104 further comprises a layer of adhesive 112 configured to securely mount the adhesive curtain rod bracket 100 onto a vertical flat surface, such as a wall. In other embodiments of the adhesive curtain rod bracket 100, the rear side 110 is configured to attach to a removable base, wherein the removable base comprises the adhesive and is configured to have the rear surface removably secured thereon.

The support member 114 comprises a hook 116 disposed on the end opposite the flat member 104. The hook 116 is configured to support a curtain rod 102. In some embodiments of the adhesive curtain rod bracket 100, the hook 116 further comprises a fastener, such as a screw, that is adapted to secure a curtain rod 102 in place within the hook, preventing the rod from sliding laterally or being accidentally lifted from the hook 116. In further embodiments of the adhesive curtain rod bracket 100, the hook 116 is comprised of two slidably attached members capable of being extended away from the flat member 104 in order to accommodate rods and curtains of varied sizes.

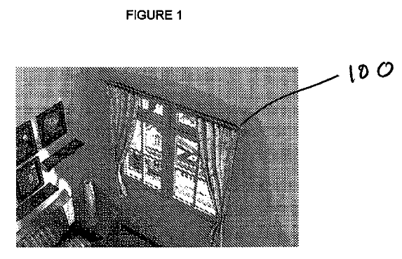

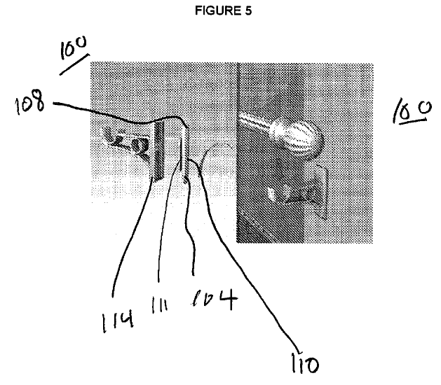

Referring now to FIGS. 1 and 5, there are shown perspective views of curtains being hung on the adhesive curtain rod bracket 100 and the components of the adhesive curtain rod bracket 100 and a curtain rod 102 being placed with the hook 116, respectively. In use, the adhesive side of the adhesive curtain rod bracket 100 is secured to a wall at the desired location with the hook 116 facing in an upward position. A curtain rod 102 is then placed within the hook 116 and may be secured with the fastener. In some embodiments, the adhesive may be easily removed by pulling down on an exposed tab of the adhesive layer, allowing for convenient readjustment when desired.

FIG. 6 illustrates a perspective view of a curtain rod bracket 200 in accordance with the present invention. FIG. 6 illustrates a cover plate 230 having notches 232 formed in both ends of the cover plate 230 making it easier to remove the cover plate 230. The cover plate 230 aligns with flat member 104 such that the cover plate 230 is symmetrical around the support member 234. The flat plate 104 may include multiple ridges to allow the cover plate 230 to be positioned at various depths, accommodating various thicknesses of adhesives. The hook 236 may include a pair of opposing protrusions 238 positioned on the concave surface of the hook 236 to allow the rod to be snapped into the hook 236 and preventing the rod from accidentally falling out of the support member 234. There is additional space under the cover plate 230 for varying amounts of adhesive.

FIG. 7 illustrates a top view of the curtain rod bracket 200 of the present invention.

FIG. 8 illustrates a side view of the curtain rod bracket 200 of the present invention.

FIG. 9 illustrates a bottom view of the curtain rod bracket 200 of the present invention

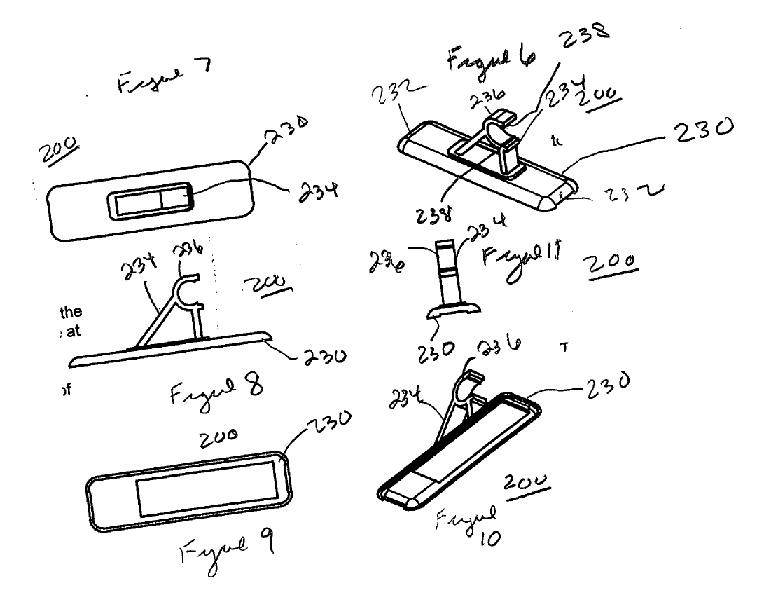

FIG. 10 illustrates a bottom perspective view of the curtain rod bracket 200 of the present invention

FIG. 11 illustrates a side view of the curtain rod bracket 200 of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1) A curtain rod bracket to support a curtain rod, comprising:
a flat member to attach to a substantially vertical wall;
a support member to connect to the flat member to support the curtain rod.

2) A curtain rod bracket to support a curtain rod as in claim 1, wherein the flat member includes a upward extending arm to connect to the support member.

3) A curtain rod bracket to support a curtain rod as in claim 1, wherein the flat member includes a pair of upward extending arms to connect to the support member.

4) A curtain rod bracket to support a curtain rod as in claim 1, wherein the support member includes a hook to support the curtain rod.

5) A curtain rod bracket to support a curtain rod as in claim 1, wherein the flat member includes a layer of removable adhesive to connect to the vertical wall.

6) A curtain rod bracket to support a curtain rod as in claim 5, wherein the layer of adhesive is connected to a tab.
